(19) United States
(12) Patent Application Publication
(10) Pub. No.: US 2023/0418586 A1
(43) Pub. Date: Dec. 28, 2023

(54) INFORMATION PROCESSING DEVICE, INFORMATION PROCESSING METHOD, AND INFORMATION PROCESSING SYSTEM

(71) Applicant: SONY GROUP CORPORATION, TOKYO (JP)

(72) Inventor: GUIFEN TIAN, TOKYO (JP)

(21) Appl. No.: 18/253,227

(22) PCT Filed: Nov. 12, 2021
(86) PCT No.: PCT/JP2021/041660

§ 371 Date: May 17, 2023

(30) Foreign Application Priority Data
Nov. 27, 2020 (JP) 2020-196743

(51) Int. Cl. G06F 8/65; G06V 20/58

(52) U.S. Cl. CPC G06F 8/65; G06V 20/58

(57) ABSTRACT

The present technology relates to an information processing device, an information processing method, and an information processing system capable of appropriately updating software used for travel assistance or automated driving of a mobile body.

An information processing device includes: a recognition unit that performs recognition processing of a situation around a mobile body on the basis of sensor data regarding the situation around the mobile body; and a software update control unit that controls update of software used for travel assistance or automated driving of the mobile body on the basis of a recognition result of the recognition processing. The present technology can be applied to, for example, a vehicle that performs automated driving.

### TECHNICAL FIELD

The present technology relates to an information processing device, an information processing method, and an information processing system, and more particularly, to an information processing device, an information processing method, and an information processing system suitable for use in a case of updating software used for travel assistance or automated driving of a mobile body.

### BACKGROUND ART

Conventionally, there have been proposed techniques of limiting a part or all of functions of travel assistance or automated driving in a case where updating of software used for travel assistance or automated driving is not permitted (see, for example, Patent Document 1).

### CITATION LIST

### Patent Document

Patent Document 1: Japanese Patent Application Laid-Open No. 2017-167646

### SUMMARY OF THE INVENTION

### Problems to be Solved by the Invention

However, in the invention described in Patent Document 1, in a case where the software installed in the vehicle is not the latest software, it is determined that the software unconditionally needs to be updated. Therefore, for example, even if software having a low necessity for updating is not updated, the function of travel assistance or automated driving is restricted.

The present technology has been made in view of such a situation, and makes it possible to appropriately update software used for travel assistance or automated driving of a mobile body.

### Solutions to Problems

An information processing device according to a first aspect of the present technology includes: a recognition unit that performs recognition processing of a situation around a mobile body on the basis of sensor data regarding the situation around the mobile body; and a software update control unit that controls update of software used for travel assistance or automated driving of the mobile body on the basis of a recognition result of the recognition processing.

An information processing method according to the first aspect of the present technology includes: performing recognition processing of a situation around a mobile body on the basis of sensor data regarding the situation around the mobile body; and controlling update of software used for travel assistance or automated driving of the mobile body on the basis of a recognition result of the recognition processing.

In the first aspect of the present technology, the recognition processing of the situation around the mobile body is performed on the basis of the sensor data regarding the situation around the mobile body, and the update of the software used for the travel assistance or the automated driving of the mobile body is controlled on the basis of the recognition result of the recognition processing.

An information processing system according to a second aspect of the present technology includes: a first information processing device provided in a mobile body; and a second information processing device, in which the first information processing device includes: a recognition unit that performs recognition processing of a situation around the mobile body on the basis of sensor data regarding the situation around the mobile body; and a software update control unit that determines whether or not it is necessary to update software used for travel assistance or automated driving of the mobile body on the basis of a recognition result of the recognition processing, and the second information processing device includes a software management unit that selects update software to be used for updating the software on the basis of a use condition of the mobile body in a case where the first information processing device determines that the software needs to be updated.

In the second aspect of the present technology, the recognition processing of the situation around the mobile body is performed on the basis of the sensor data regarding the situation around the mobile body, it is determined whether or not it is necessary to update the software used for the travel assistance or the automated driving of the mobile body on the basis of the recognition result of the recognition processing, and in a case where it is determined that the software needs to be updated, the update software to be used for updating the software is selected on the basis of the use condition of the mobile body.

### BRIEF DESCRIPTION OF DRAWINGS

FIG. 1 is a block diagram illustrating a configuration example of a vehicle control system.

FIG. 2 is a diagram illustrating examples of sensing areas.

FIG. 3 is a block diagram illustrating an embodiment of an information processing system to which the present technology is applied.

FIG. 4 is a block diagram illustrating a configuration example of a vehicle and a management server in FIG. 3.

FIG. 5 is a table illustrating a configuration example of software management data.

FIG. 6 is a table illustrating a configuration example of a vehicle DB.

FIG. 7 is a diagram illustrating a specific example of data stored in a registration information DB.

FIG. 8 is a block diagram illustrating a configuration example of a recognition unit in FIG. 4.

FIG. 9 is a flowchart for explaining software update control processing.

FIG. 10 is a flowchart for explaining details of recognition processing.

FIG. 11 is a table illustrating a configuration example of recognition processing information.

FIG. 12 is a diagram illustrating a display example of information regarding update software.

FIG. 13 is a diagram illustrating a display example of information regarding update software.

FIG. 14 is a flowchart for explaining details of operation mode control processing.

FIG. 15 is a flowchart for explaining software provision processing.

FIG. 16 is a diagram for explaining a first embodiment of a method of selecting update software.

FIG. 17 is a diagram for explaining a second embodiment of a method of selecting update software.

FIG. 18 is a diagram for explaining a second embodiment of a method of selecting update software.

FIG. 19 is a block diagram illustrating a configuration example of a computer.

### MODE FOR CARRYING OUT THE INVENTION

Hereinafter, a mode for carrying out the present technology will be described. Note that the description will be given in the following order.
1. Configuration Example of Vehicle Control System
2. Embodiments
3. Modifications
4. Others

### 1. Configuration Example of Vehicle Control System

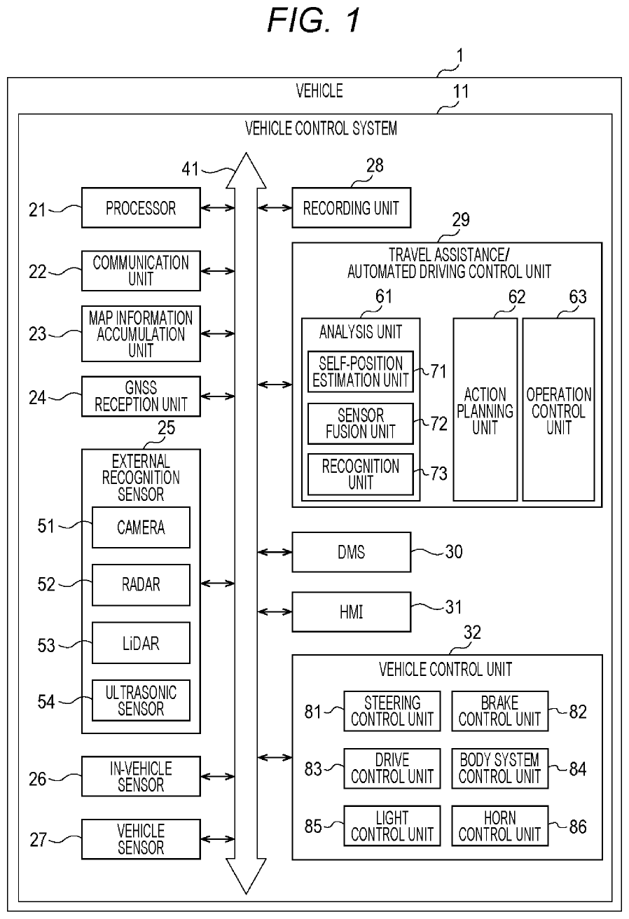

FIG. 1 is a block diagram illustrating a configuration example of a vehicle control system 11 which is an example of a mobile device control system to which the present technology is applied.

The vehicle control system 11 is provided in a vehicle 1 and performs processing related to travel assistance and automated driving of the vehicle 1.

The vehicle control system 11 includes a processor 21, a communication unit 22, a map information accumulation unit 23, a global navigation satellite system (GNSS) reception unit 24, an external recognition sensor 25, an in-vehicle sensor 26, a vehicle sensor 27, a recording unit 28, a travel assistance/automated driving control unit 29, a driver monitoring system (DMS) 30, a human machine interface (HMI) 31, and a vehicle control unit 32.

The processor 21, the communication unit 22, the map information accumulation unit 23, the GNSS reception unit 24, the external recognition sensor 25, the in-vehicle sensor 26, the vehicle sensor 27, the recording unit 28, the travel assistance/automated driving control unit 29, the driver monitoring system (DMS) 30, the human machine interface (HMI) 31, and the vehicle control unit 32 are connected to one another via a communication network 41. The communication network 41 includes, for example, an in-vehicle communication network, a bus, or the like conforming to an arbitrary standard such as a controller area network (CAN), a local interconnect network (LIN), a local area network (LAN), FlexRay (registered trademark), Ethernet, or the like. Note that there is also a case where each unit of the vehicle control system 11 is directly connected by, for example, near field communication (NFC), Bluetooth (registered trademark), and the like without passing through the communication network 41.

Note that, hereinafter, in a case where each unit of the vehicle control system 11 performs communication via the communication network 41, description of the communication network 41 will be omitted. For example, in a case where the processor 21 and the communication unit 22 perform communication via the communication network 41, it is simply described that the processor 21 and the communication unit 22 perform communication.

The processor 21 includes various processors such as a central processing unit (CPU), a micro processing unit (MPU), and an electronic control unit (ECU), for example. The processor 21 controls the entire vehicle control system 11.

The communication unit 22 communicates with various devices inside and outside the vehicle, other vehicles, servers, base stations, and the like, and transmits and receives various data. As the communication with the outside of the vehicle, for example, the communication unit 22 receives a program for updating software for controlling the operation of the vehicle control system 11, map information, traffic information, information around the vehicle 1, and the like from the outside. For example, the communication unit 22 transmits information regarding the vehicle 1 (for example, data indicating the state of the vehicle 1, a recognition result by the recognition unit 73, and the like), information around the vehicle 1, and the like to the outside. For example, the communication unit 22 performs communication corresponding to a vehicle emergency call system such as an eCall and the like.

Note that a communication system of the communication unit 22 is not particularly limited. Furthermore, a plurality of communication systems may be used.

As the communication with the inside of the vehicle, for example, the communication unit 22 performs wireless communication with a device in the vehicle by a communication system such as wireless LAN, Bluetooth, NFC, wireless USB (WUSB), and the like. For example, the communication unit 22 performs wired communication with a device in the vehicle by a communication system such as a universal serial bus (USB), a high-definition multimedia interface (HDMI, registered trademark), a mobile high-definition link (MHL), and the like via a connection terminal (not illustrated) (and a cable if necessary).

Here, the device in the vehicle is, for example, a device that is not connected to the communication network 41 in the vehicle. For example, a mobile device or a wearable device carried by an occupant such as a driver and the like, an information device brought into the vehicle and temporarily installed, and the like are assumed.

For example, the communication unit 22 communicates with a server and the like existing on an external network (for example, the Internet, a cloud network, or a company-specific network) via a base station or an access point by a wireless communication system such as the fourth generation mobile communication system (4G), the fifth generation mobile communication system (5G), long term evolution (LTE), dedicated short range communications (DSRC), and the like.

For example, the communication unit 22 communicates with a terminal existing in the vicinity of a host vehicle (for example, a terminal of a pedestrian or a store, or a machine type communication (MTC) terminal) using a peer to peer (P2P) technology. For example, the communication unit 22 performs V2X communication. The V2X communication is, for example, vehicle to vehicle communication with another vehicle, vehicle to infrastructure communication with a roadside device and the like, vehicle to home communication, vehicle to pedestrian communication with a terminal and the like possessed by a pedestrian, and the like.

For example, the communication unit 22 receives an electromagnetic wave transmitted by a vehicle information and communication system ((VICS), registered trademark) such as a radio wave beacon, an optical beacon, FM multiplex broadcasting, and the like.

The map information accumulation unit 23 accumulates a map acquired from the outside and a map created by the vehicle 1. For example, the map information accumulation unit 23 accumulates a three-dimensional high-precision map, a global map having lower precision than the high-precision map and covering a wide area, and the like.

The high-precision map is, for example, a dynamic map, a point cloud map, a vector map (also referred to as an advanced driver assistance system (ADAS) map), and the like. The dynamic map is, for example, a map including four layers of dynamic information, semi-dynamic information, semi-static information, and static information, and is provided from an external server or the like. The point cloud map is a map including point clouds (point cloud data). The vector map is a map in which information such as a lane, a position of a signal, and the like is associated with the point cloud map. The point cloud map and the vector map may be provided from, for example, an external server or the like, or may be created by the vehicle 1 as a map for performing matching with a local map to be described later on the basis of a sensing result by a radar 52, a LiDAR 53, or the like, and may be accumulated in the map information accumulation unit 23. Furthermore, in a case where the high-precision map is provided from the external server and the like, for example, map data of several hundred square meters regarding a planned route on which the vehicle 1 travels from now is acquired from the server and the like in order to reduce a communication capacity.

The GNSS reception unit 24 receives a GNSS signal from a GNSS satellite, and supplies the GNSS signal to the travel assistance/automated driving control unit 29.

The external recognition sensor 25 includes various sensors used for recognizing a situation outside the vehicle 1, and supplies sensor data from each sensor to each unit of the vehicle control system 11. The type and number of sensors included in the external recognition sensor 25 are arbitrary.

For example, the external recognition sensor 25 includes a camera 51, the radar 52, the light detection and ranging or laser imaging detection and ranging (LiDAR) 53, and an ultrasonic sensor 54. The number of the cameras 51, the radars 52, the LiDAR 53, and the ultrasonic sensors 54 is arbitrary, and an example of a sensing area of each sensor will be described later.

Note that, as the camera 51, for example, a camera of an arbitrary imaging system such as a time of flight (ToF) camera, a stereo camera, a monocular camera, an infrared camera, and the like is used as necessary.

Furthermore, for example, the external recognition sensor 25 includes an environment sensor for detecting weather, meteorological phenomena, brightness, and the like. The environment sensor includes, for example, a raindrop sensor, a fog sensor, a sunshine sensor, a snow sensor, an illuminance sensor, and the like.

Moreover, for example, the external recognition sensor 25 includes a microphone used for detecting a sound around the vehicle 1, a position of a sound source, and the like.

The in-vehicle sensor 26 includes various sensors for detecting information inside the vehicle, and supplies sensor data from each sensor to each unit of the vehicle control system 11. The type and number of sensors included in the in-vehicle sensor 26 are arbitrary.

For example, the in-vehicle sensor 26 includes a camera, a radar, a seating sensor, a steering wheel sensor, a microphone, a biological sensor, and the like. As the camera, for example, a camera of any imaging system such as a ToF camera, a stereo camera, a monocular camera, an infrared camera, or the like can be used. The biological sensor is provided, for example, on a seat, a steering wheel, and the like, and detects various types of biological information of an occupant such as a driver and the like.

The vehicle sensor 27 includes various sensors for detecting a state of the vehicle 1, and supplies sensor data from each sensor to each unit of the vehicle control system 11. The type and number of sensors included in the vehicle sensor 27 are arbitrary.

For example, the vehicle sensor 27 includes a speed sensor, an acceleration sensor, an angular velocity sensor (gyro sensor), and an inertial measurement unit (IMU). For example, the vehicle sensor 27 includes a steering angle sensor that detects a steering angle of a steering wheel, a yaw rate sensor, an accelerator sensor that detects an operation amount of an accelerator pedal, and a brake sensor that detects an operation amount of a brake pedal. For example, the vehicle sensor 27 includes a rotation sensor that detects the number of rotations of the engine or the motor, an air pressure sensor that detects the air pressure of the tire, a slip rate sensor that detects the slip rate of the tire, and a wheel speed sensor that detects the rotation speed of the wheel. For example, the vehicle sensor 27 includes a battery sensor that detects a remaining amount and temperature of a battery and an impact sensor that detects an external impact.

The recording unit 28 includes, for example, a read only memory (ROM), a random access memory (RAM), a magnetic storage device such as a hard disc drive (HDD) and the like, a semiconductor storage device, an optical storage device, a magneto-optical storage device, and the like. The recording unit 28 records various programs, data, and the like used by each unit of the vehicle control system 11. For example, the recording unit 28 records a rosbag file including a message transmitted and received by a robot operating system (ROS) in which an application program related to automated driving operates. For example, the recording unit 28 includes an event data recorder (EDR) and a data storage system for automated driving (DSSAD), and records information of the vehicle 1 before and after an event such as an accident and the like.

The travel assistance/automated driving control unit 29 controls travel assistance and automated driving of the vehicle 1. For example, the travel assistance/automated driving control unit 29 includes an analysis unit 61, an action planning unit 62, and an operation control unit 63.

The analysis unit 61 performs analysis processing of a situation of the vehicle 1 and the surroundings. The analysis unit 61 includes a self-position estimation unit 71, a sensor fusion unit 72, and the recognition unit 73.

The self-position estimation unit 71 estimates a self-position of the vehicle 1 on the basis of sensor data from the external recognition sensor 25 and a high-precision map accumulated in the map information accumulation unit 23. For example, the self-position estimation unit 71 generates a local map on the basis of sensor data from the external recognition sensor 25, and estimates the self-position of the vehicle 1 by matching the local map with the high-precision map. The position of the vehicle 1 is based on, for example, the center of a rear wheel pair axle.

The local map is, for example, a three-dimensional high-precision map created using a technique such as simultaneous localization and mapping (SLAM) and the like, an occupancy grid map, and the like. The three-dimensional high-precision map is, for example, the above-described point cloud map or the like. The occupancy grid map is a map in which a three-dimensional or two-dimensional space around the vehicle 1 is divided into grids of a predetermined size, and an occupancy state of an object is indicated in units of grids. The occupancy state of the object is indicated by, for example, the presence or absence or existence probability of the object. The local map is also used for detection processing and recognition processing of a situation outside the vehicle 1 by the recognition unit 73, for example.

Note that the self-position estimation unit 71 may estimate the self-position of the vehicle 1 on the basis of a GNSS signal and sensor data from the vehicle sensor 27.

The sensor fusion unit 72 performs sensor fusion processing of combining a plurality of different types of sensor data (for example, image data supplied from the camera 51 and sensor data supplied from the radar 52) to obtain new information. Methods for combining different types of sensor data include integration, fusion, association, and the like.

The recognition unit 73 performs detection processing and recognition processing of a situation outside the vehicle 1.

For example, the recognition unit 73 performs detection processing and recognition processing of the situation outside the vehicle 1 on the basis of information from the external recognition sensor 25, information from the self-position estimation unit 71, information from the sensor fusion unit 72, and the like.

Specifically, for example, the recognition unit 73 performs detection processing, recognition processing, and the like of an object around the vehicle 1. The object detection processing is, for example, processing of detecting the presence or absence, size, shape, position, movement, and the like of an object. The object recognition processing is, for example, processing of recognizing an attribute such as a type of an object or the like or identifying a specific object. However, the detection processing and the recognition processing are not necessarily clearly divided, and there is a case where the processing overlaps.

For example, the recognition unit 73 detects an object around the vehicle 1 by performing clustering for classifying point clouds based on sensor data from the LiDAR, the radar, and the like for each cluster of point clouds. Therefore, the presence or absence, size, a shape, and a position of the object around the vehicle 1 are detected.

For example, the recognition unit 73 detects a motion of the object around the vehicle 1 by performing tracking that follows a motion of the cluster of point clouds classified by clustering. Therefore, a speed and a traveling direction (movement vector) of the object around the vehicle 1 are detected.

For example, the recognition unit 73 recognizes a type of the object around the vehicle 1 by performing object recognition processing such as semantic segmentation and the like on image data supplied from the camera 51.

Note that, as the object to be detected or recognized, for example, a vehicle, a person, a bicycle, an obstacle, a structure, a road, a traffic light, a traffic sign, a road sign, and the like are assumed.

For example, the recognition unit 73 performs recognition processing of traffic rules around the vehicle 1 on the basis of a map accumulated in the map information accumulation unit 23, an estimation result of the self-position, and a recognition result of the object around the vehicle 1. By this processing, for example, a position and a state of the signal, contents of the traffic sign and the road sign, contents of a traffic regulation, a travelable lane, and the like are recognized.

For example, the recognition unit 73 performs recognition processing of an environment around the vehicle 1. As the surrounding environment to be recognized, for example, weather, temperature, humidity, brightness, a state of a road surface, and the like are assumed.

The action planning unit 62 creates an action plan of the vehicle 1. For example, the action planning unit 62 creates the action plan by performing processing of global path planning and path following.

Note that the global path planning is processing of planning a rough path from a start to a goal. This global path planning includes processing of local path generation called local path planning that enables safe and smooth traveling in the vicinity of the vehicle 1 in consideration of motion characteristics of the vehicle 1 in the path planned by the global path planning.

The path following is processing of planning operation for safely and accurately traveling the path planned by the global path planning within a planned time. For example, a target speed and a target angular velocity of the vehicle 1 are calculated.

The operation control unit 63 controls operation of the vehicle 1 in order to realize the action plan created by the action planning unit 62.

For example, the operation control unit 63 controls a steering control unit 81, a brake control unit 82, and a drive control unit 83 to perform acceleration/deceleration control and direction control such that the vehicle 1 travels on the local path calculated by the local path planning. For example, the operation control unit 63 performs cooperative control for the purpose of implementing the functions of the ADAS such as collision avoidance or impact mitigation, follow-up traveling, vehicle speed maintaining traveling, collision warning of the host vehicle, lane deviation warning of the host vehicle, and the like. For example, the operation control unit 63 performs cooperative control for the purpose of automated driving and the like in which a vehicle autonomously travels without depending on an operation of a driver.

The DMS 30 performs authentication processing of a driver, recognition processing of a state of the driver, and the like on the basis of sensor data from the in-vehicle sensor 26, input data input to the HMI 31, and the like. As the state of the driver to be recognized, for example, a physical condition, a wakefulness level, a concentration level, a fatigue level, a line-of-sight direction, a drunkenness level, a driving operation, a posture, and the like are assumed.

Note that the DMS 30 may perform authentication processing of an occupant other than the driver and recognition processing of a state of the occupant. Furthermore, for example, the DMS 30 may perform recognition processing of the situation inside the vehicle on the basis of sensor data from the in-vehicle sensor 26. As the situation inside the vehicle to be recognized, for example, temperature, humidity, brightness, odor, and the like are assumed.

The HMI 31 is used for inputting various data, instructions, and the like, generates an input signal on the basis of the input data, instructions, and the like, and supplies the input signal to each unit of the vehicle control system 11. For example, the HMI 31 includes an operation device such as a touch panel, a button, a microphone, a switch, a lever, and the like, an operation device that can input by a method other than manual operation such as voice, gesture, or the like, and the like. Note that the HMI 31 may be, for example, a remote control device using infrared rays or other radio waves, or an external connection device such as a mobile device, a wearable device, and the like compatible with an operation of the vehicle control system 11.

Furthermore, the HMI 31 generates and outputs visual information, auditory information, and tactile information to an occupant or the outside of the vehicle, and performs output control to control output contents, an output timing, an output method, and the like. The visual information is, for example, information indicated by an image or light such as an operation screen, a state display of the vehicle 1, a warning display, a monitor image indicating a situation around the vehicle 1, or the like. The auditory information is, for example, information indicated by sound such as guidance, a warning sound, a warning message, or the like. The tactile information is, for example, information given to a tactile sense of an occupant by force, vibration, a motion, and the like.

As a device that outputs the visual information, for example, a display device, a projector, a navigation device, an instrument panel, a camera monitoring system (CMS), an electronic mirror, a lamp, and the like are assumed. The display device may be, for example, a device that displays visual information in a field of view of an occupant, such as a head-up display, a transmissive display, a wearable device having an augmented reality (AR) function, and the like, in addition to a device having a normal display.

As a device that outputs the auditory information, for example, an audio speaker, a headphone, an earphone, and the like are assumed.

As a device that outputs the tactile information, for example, a haptic element using haptic technology and the like are assumed. The haptic element is provided, for example, on a steering wheel, a seat, and the like.

The vehicle control unit 32 controls each unit of the vehicle 1. The vehicle control unit 32 includes the steering control unit 81, the brake control unit 82, the drive control unit 83, a body system control unit 84, a light control unit 85, and a horn control unit 86.

The steering control unit 81 performs detection, control, and the like of a state of a steering system of the vehicle 1. The steering system includes, for example, a steering mechanism including a steering wheel and the like, an electric power steering, and the like. The steering control unit 81 includes, for example, a control unit such as an ECU and the like that controls the steering system, an actuator that drives the steering system, and the like.

The brake control unit 82 performs detection, control, and the like of a state of a brake system of the vehicle 1. The brake system includes, for example, a brake mechanism including a brake pedal, an antilock brake system (ABS), and the like. The brake control unit 82 includes, for example, a control unit such as an ECU and the like that controls the brake system, an actuator that drives the brake system, and the like.

The drive control unit 83 performs detection, control, and the like of a state of a drive system of the vehicle 1. The drive system includes, for example, a driving force generation device for generating a driving force such as an accelerator pedal, an internal combustion engine, a driving motor, or the like, a driving force transmission mechanism for transmitting the driving force to wheels, and the like. The drive control unit 83 includes, for example, a control unit such as an ECU and the like that controls the drive system, an actuator that drives the drive system, and the like.

The body system control unit 84 performs detection, control, and the like of a state of a body system of the vehicle 1. The body system includes, for example, a keyless entry system, a smart key system, a power window device, a power seat, an air conditioner, an airbag, a seat belt, a shift lever, and the like. The body system control unit 84 includes, for example, a control unit such as an ECU and the like that controls the body system, an actuator that drives the body system, and the like.

The light control unit 85 performs detection, control, and the like of states of various lights of the vehicle 1. As the light to be controlled, for example, a headlight, a backlight, a fog light, a turn signal, a brake light, a projection, a display of a bumper, and the like are assumed. The light control unit 85 includes a control unit such as an ECU and the like that controls the light, an actuator that drives the light, and the like.

The horn control unit 86 performs detection, control, and the like of a state of a car horn of the vehicle 1. The horn control unit 86 includes, for example, a control unit such as an ECU and the like that controls the car horn, an actuator that drives the car horn, and the like.

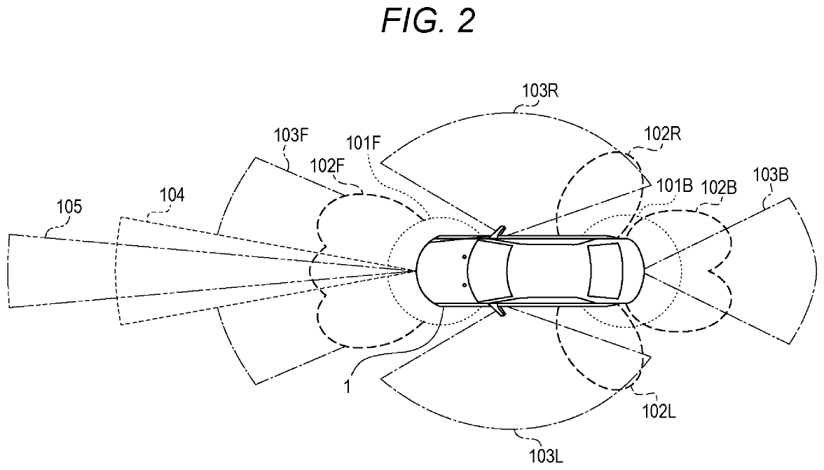

FIG. 2 is a diagram illustrating examples of sensing areas by the camera 51, the radar 52, the LiDAR 53, and the ultrasonic sensor 54 of the external recognition sensor 25 in FIG. 1.

A sensing area 101F and a sensing area 101B illustrate examples of sensing areas by the ultrasonic sensor 54. The sensing area 101F covers the periphery of the front end of the vehicle 1. The sensing area 101B covers the periphery of the rear end of the vehicle 1.

Sensing results in the sensing area 101F and the sensing area 101B are used, for example, for parking assistance and the like of the vehicle 1.

Sensing areas 102F to 102B illustrate examples of sensing areas by the radar 52 for a short distance or a middle distance. The sensing area 102F covers a position farther than the sensing area 101F in front of the vehicle 1. The sensing area 102B covers a position farther than the sensing area 101B behind the vehicle 1. A sensing area 102L covers the rear periphery of the left side surface of the vehicle 1. A sensing area 102R covers the rear periphery of a right side surface of the vehicle 1.

A sensing result in the sensing area 102F is used, for example, for detection and the like of a vehicle, a pedestrian, and the like existing in front of the vehicle 1. A sensing result in the sensing area 102B is used, for example, for a collision prevention function or the like behind the vehicle 1. Sensing results in the sensing area 102L and the sensing area 102R are used, for example, for detection and the like of an object in a blind spot on the side of the vehicle 1.

Sensing areas 103F to 103B illustrate examples of sensing areas by the camera 51. The sensing area 103F covers a position farther than the sensing area 102F in front of the vehicle 1. The sensing area 103B covers a position farther than the sensing area 102B behind the vehicle 1. A sensing area 103L covers the periphery of the left side surface of the vehicle 1. A sensing area 103R covers the periphery of the right side surface of the vehicle 1.

A sensing result in the sensing area 103F is used for, for example, recognition of a traffic light or a traffic sign, a lane departure prevention assist system, and the like. A sensing result in the sensing area 103B is used for, for example, parking assistance, a surround view system, and the like. Sensing results in the sensing area 103L and the sensing area 103R are used for, for example, a surround view system and the like.

A sensing area 104 illustrates an example of a sensing area by the LiDAR 53. The sensing area 104 covers a position farther than the sensing area 103F in front of the vehicle 1. Meanwhile, the sensing area 104 has a narrower range in a left-right direction than the sensing area 103F.

A sensing result in the sensing area 104 is used for, for example, emergency braking, collision avoidance, pedestrian detection, and the like.

A sensing area 105 illustrates an example of a sensing area by the radar 52 for a long distance. The sensing area 105 covers a position farther than the sensing area 104 in front of the vehicle 1. Meanwhile, the sensing area 105 has a narrower range in the left-right direction than the sensing area 104.

A sensing result in the sensing area 105 is used for, for example, adaptive cruise control (ACC) and the like.

Note that the sensing area of each sensor may have various configurations other than those in FIG. 2. Specifically, the ultrasonic sensor 54 may also sense the side of the vehicle 1, or the LiDAR 53 may sense the rear of the vehicle 1.

### 2. Embodiments

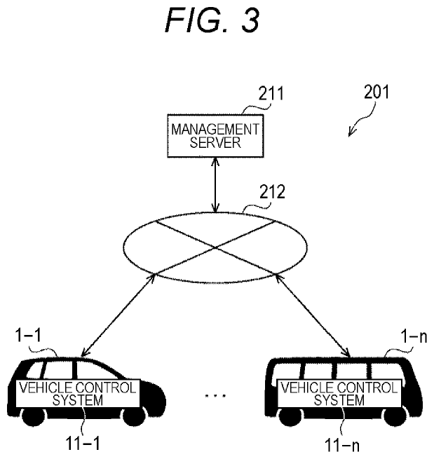

Next, embodiments of the present technology will be described with reference to FIGS. 3 to 18.

### Configuration Example of Information Processing System

FIG. 3 illustrates an embodiment of an information processing system 201 to which the present technology is applied.

The information processing system 201 is a system that manages and updates software (hereinafter, referred to as software for automated driving and the like) used for travel assistance or automated driving of the vehicle 1-1 to the vehicle 1-n.

Here, the travel assistance function is, for example, a function of assisting the driver at level 1 or level 2 of automated driving. For example, the travel assistance function includes an automatic braking function, a cruise control function, a lane keeping assist function, and the like. The automatic braking function is, for example, a function of automatically decelerating or stopping the vehicle 1 in a case of sensing danger. The cruise control function is, for example, a function of automatically following a vehicle ahead while maintaining an inter-vehicle distance. The lane keeping assist function is, for example, a function of automatically maintaining a traveling lane and preventing deviation from the lane.

The automated driving function is, for example, a function in which the vehicle 1 automatically travels even if the driver does not operate at levels 3 to 5 of automated driving. However, at level 3 of the automated driving, the operation of the driver may be requested.

Furthermore, the software for automated driving and the like includes not only software directly used for control of travel assistance or automated driving but also software indirectly used for control of travel assistance or automated driving. For example, software or the like used for object recognition for performing travel assistance or automated driving is included.

The information processing system 201 includes a vehicle 1-1 to a vehicle 1-n and a management server 211. The vehicles 1-1 to 1-n and the management server 211 can communicate with each other via a network 212.

The management server 211 provides and manages software used in the vehicles 1-1 to 1-n or the like.

As described above, the vehicles 1-1 to 1-n include vehicle control systems 11-1 to 11-n, respectively.

Note that, hereinafter, in a case where it is not necessary to individually distinguish the vehicles 1-1 to 1-n, they are simply referred to as the vehicle 1. Hereinafter, in a case where it is not necessary to individually distinguish the vehicle control systems 11-1 to 11n, they are simply referred to as the vehicle control system 11.

### Configuration Examples of Management Server 211 and Vehicle 1

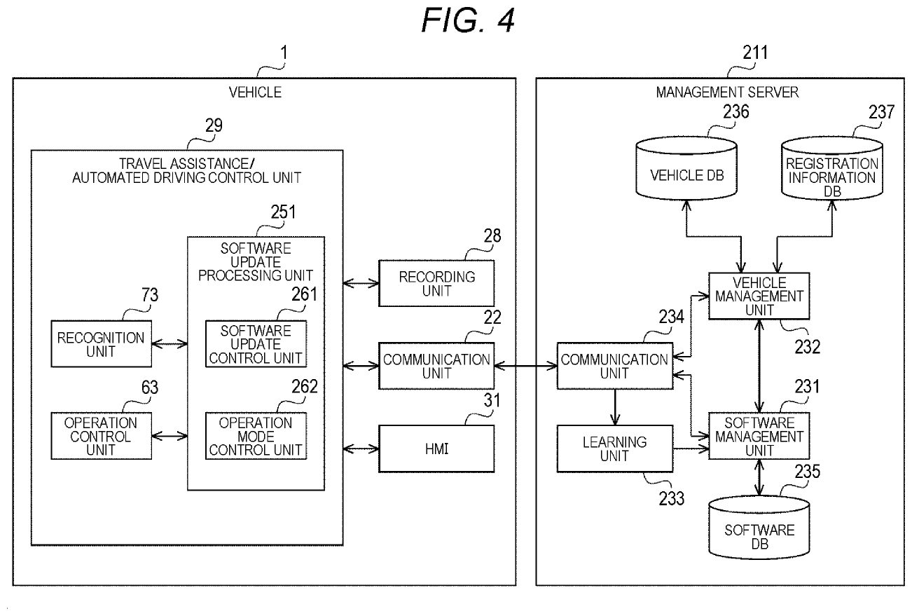

FIG. 4 illustrates a configuration example of a part related to update of software in the management server 211 and the vehicle 1. Note that, in the drawing, portions corresponding to those in FIG. 1 are denoted by the same reference numerals, and the description thereof will be omitted as appropriate. Furthermore, in FIG. 4, the communication network 41 and the network 212 are not illustrated.

The management server 211 includes a software management unit 231, a vehicle management unit 232, a learning unit 233, a communication unit 234, a software database (DB) 235, a vehicle database (DB) 236, and a registration information database (DB) 237.

The software management unit 231 manages software used in each vehicle 1. For example, the software management unit 231 updates software stored in the software DB 235 and data related to the software. The software management unit 231 selects software (hereinafter, referred to as update software) used for updating the software of the vehicle 1 on the basis of the data stored in the software DB 235, the vehicle DB 236, and the registration information DB 237 and the recognition result of the recognition processing in each vehicle 1. The software management unit 231 transmits update software information including information regarding the selected update software to each vehicle 1 via the communication unit 234 and the network 212. The software management unit 231 transmits update software requested from each vehicle 1 to the requester vehicle 1 via the communication unit 234 and the network 212.

Note that the update software is not limited to software that updates all the software to be updated. For example, the update software includes software (for example, software for applying a patch) that updates only a part of the software to be updated. In addition, the update software includes software (for example, software for plug-in) that adds a function to the software to be updated.

The vehicle management unit 232 manages data related to software, use conditions, and the like of each vehicle 1. For example, the vehicle management unit 232 updates data stored in the vehicle DB 236 and the registration information DB 237.

The learning unit 233 learns the recognition processing on the basis of the recognition result of the recognition processing in each vehicle 1 and updates the software for the recognition processing. The learning unit 233 stores the updated software in the software DB 235 via the software management unit 231.

The communication unit 234 communicates with each vehicle 1 via the network 212, and transmits and receives various types of software and data.

The software DB 235 stores software used in each vehicle 1 and data related to each software (referred to as software management data).

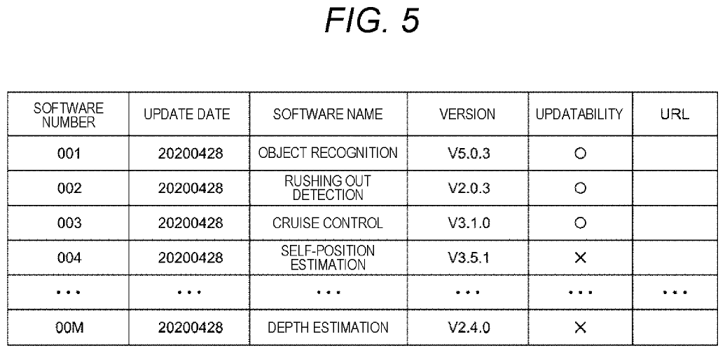

FIG. 5 illustrates a configuration example of the software management data. The software management data includes a software number, an update date, a software name, a version, updatability, and a uniform resource locator (URL).

The software number is a number for uniquely identifying each software.

The update date indicates a date on which each piece of software is updated.

The software name indicates a name of each software. For example, a name representing a function of each software is given to the name of each software.

The version indicates the latest version of each software.

The updatability indicates whether or not each piece of software can be updated. For example, the software set to be updatable can provide the latest version of software to each vehicle 1 and install the software. Meanwhile, the software set to be not updateable is software for checking whether the basic function of the automated driving performs an expected operation with respect to a specific input, and is not updated.

The URL indicates a URL as a software acquisition destination.

In the example of FIG. 5, for example, it is illustrated that the software for object recognition with the software number 001 is updated to version V5.0.3 on Apr. 28, 2020 and can be updated in each vehicle 1.

The vehicle DB 236 manages data and the like related to software installed in each vehicle 1.

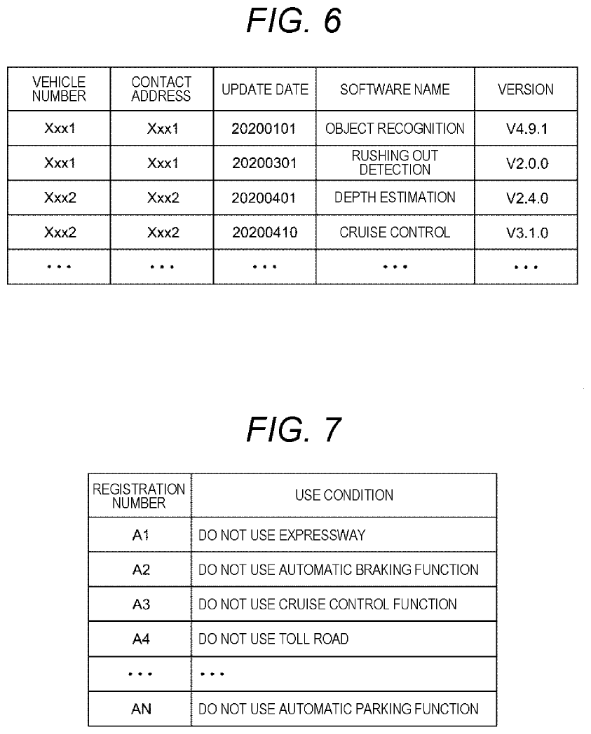

FIG. 6 illustrates a configuration example of data of the vehicle DB 236. The vehicle DB 236 includes a vehicle number, a contact address, an update date, a type of software, and a version.

The vehicle number is a number for identifying each vehicle 1.

The contact indicates a contact address to a user (owner) of each vehicle 1. For example, a mail address being a transmission destination of update software information, software, or the like is set.

The update date indicates the date on which the target software in each vehicle 1 was updated (the date on which the target software was installed or upgraded).

As the software name, a name of software installed in each vehicle 1 is set. This software name corresponds to the software name of the software management data in FIG. 5.

The version indicates a version of software installed in each vehicle 1.

For example, this example illustrates that in the vehicle 1 with the vehicle number Xxx1, the software for object recognition was updated to the version V4.91 on Jan. 1, 2020.

The registration information DB 237 stores registration information registered in advance regarding the use condition of each vehicle 1.

FIG. 7 illustrates a specific example of data stored in the registration information DB 237.

The registration information DB 237 stores, for each vehicle 1, a vehicle number and a registration number indicating a corresponding use condition among the registration numbers A1 to AN in FIG. 7.

For example, the registration number A1 indicates that the vehicle 1 does not use an expressway.

The registration number A2 indicates that the vehicle 1 does not use the automatic braking function. Here, the case where the automatic braking function is not used includes not only the case where the vehicle 1 has the automatic function but also the case where the vehicle 1 does not have the automatic braking function.

The registration number A3 indicates that the vehicle 1 does not use the cruise control function. Here, the case where the cruise control function is not used includes not only the case where the vehicle 1 has the cruise control function but also the case where the vehicle 1 does not have the cruise control function.

The registration number A4 indicates that the vehicle 1 does not use a toll road.

The registration number AN indicates that the vehicle 1 does not use the automatic parking function. Here, a case where the automatic parking function is not used includes not only a case where the vehicle 1 has the automatic parking function but also a case where the vehicle 1 does not have the automatic parking function.

As described above, the vehicle 1 includes the communication unit 22, the recording unit 28, the travel assistance/automated driving control unit 29, the HMI 31, and the like.

The communication unit 22 communicates with the management server 211 via the network 212, and transmits and receives various kinds of software and data.

In the recording unit 28, for example, software for automated driving or the like of the vehicle 1 is installed.

The travel assistance/automated driving control unit 29 includes a software update processing unit 251 in addition to the configuration described above with reference to FIG. 1.

The software update processing unit 251 performs processing related to the update of the software of the vehicle 1. The software update processing unit 251 includes a software update control unit 261 and an operation mode control unit 262.

The software update control unit 261 controls update of software for automated driving and the like of the vehicle 1.

For example, the software update control unit 261 determines whether or not it is necessary to update the software for automated driving or the like on the basis of recognition results of various recognition processing by the recognition unit 73. In a case of determining that the software for automated driving or the like needs to be updated, the software update control unit 261 transmits recognition processing information including a recognition result by the recognition unit 73 to the management server 211 via the communication unit 22 and the network 212.

For example, the software update control unit 261 receives the update software information via the network 212 and the communication unit 22, and displays a screen based on the update software information on the HMI 31. In a case where the installation (version upgrade) of the update software displayed on the HMI 131 is permitted, the software update control unit 261 downloads the target update software from the management server 211 via the communication unit 22 and the network 212. The software update control unit 261 updates the software for automated driving or the like by installing the downloaded update software in the recording unit 28.

The operation mode control unit 262 controls the operation mode of the vehicle 1 on the basis of the recognition result of the recognition unit 73, the update status of the software for automated driving, and the like. The operation control unit 63 restricts some or all of the functions of travel assistance and automated driving according to the operation mode.

### Configuration Example of Recognition Unit 73

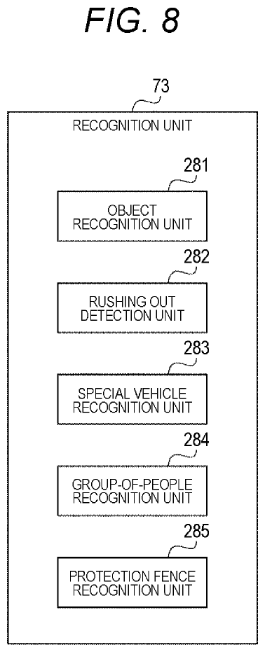

FIG. 8 illustrates a configuration example of the recognition unit 73 in FIG. 7.

The recognition unit 73 includes an object recognition unit 281, a rushing out detection unit 282, a special vehicle recognition unit 283, a group-of-people recognition unit 284, and a protection fence recognition unit 285.

The object recognition unit 281 performs object recognition processing of the front of the vehicle 1 on the basis of, for example, an image (hereinafter, referred to as a front image) obtained by imaging the front of the vehicle 1 by the camera 51 in FIG. 1.

For example, the rushing out detection unit 282 performs detection processing of rushing out in front of the vehicle 1 on the basis of the front image.

For example, the special vehicle recognition unit 283 performs recognition processing of a special vehicle in front of the vehicle 1 on the basis of the front image.

Here, the special vehicle is, for example, a vehicle that does not necessarily follow general traffic rules, such as a patrol car, an ambulance, a garbage truck, and a construction vehicle.

For example, the group-of-people recognition unit 284 performs recognition processing of a protection fence in front of the vehicle 1 on the basis of the front image.

Here, the group of people is, for example, a group of a predetermined number or more of people.

For example, the protection fence recognition unit 285 performs recognition processing of a protection fence in front of the vehicle 1 on the basis of the front image.

Here, the protection fence is, for example, a fence that prevents a person, an animal, or the like from rushing out to a roadway. Note that the protection fence is not necessarily installed for the purpose of preventing rushing out, but is only required to have an effect of preventing rushing out as a result. The protection fence includes, for example, a vehicle protection fence such as a guard rail, a guard pipe, a guard cable, and a box beam, and a pedestrian bicycle fence such as a random crossing preventing fence and a fall preventing fence.

### Processing of Information Processing System 201

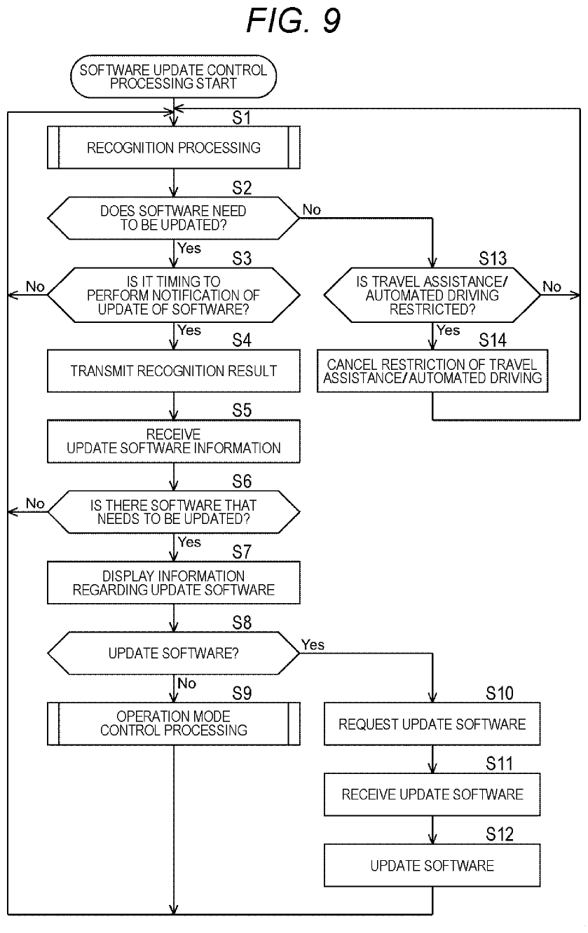

Next, processing of the information processing system 201 will be described with reference to FIGS. 9 to 18.

### Software Update Control Processing

First, software update control processing executed by the vehicle 1 will be described with reference to a flowchart of FIG. 9.

This processing is started, for example, when an operation for starting the vehicle 1 and starting driving is performed, for example, when an ignition switch, a power switch, a start switch, or the like of the vehicle 1 is turned on. Furthermore, this processing ends, for example, when an operation for ending driving of the vehicle 1 is performed, for example, when an ignition switch, a power switch, a start switch, or the like of the vehicle 1 is turned off.

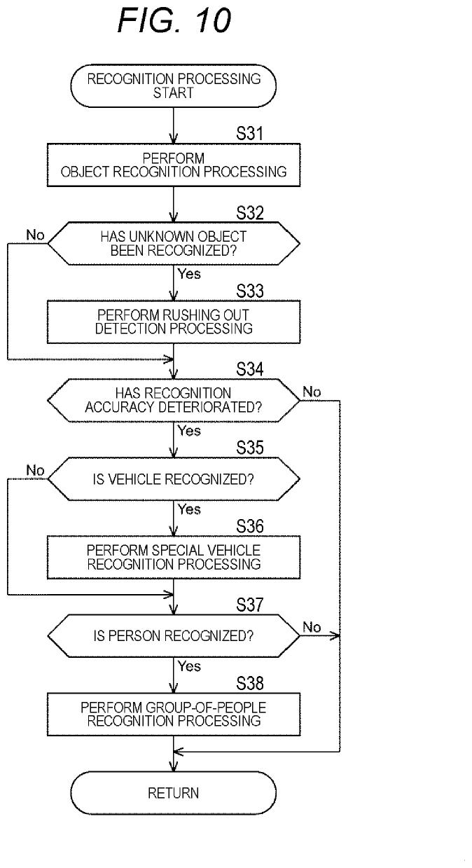

In step S1, the recognition unit 73 performs recognition processing. Here, details of the authentication processing will be described with reference to the flowchart of FIG. 10.

In step S31, the object recognition unit 281 performs object recognition processing. Specifically, the camera 51 supplies a front image obtained by imaging the front of the vehicle 1 to the recognition unit 73. The object recognition unit 281 of the recognition unit 73 recognizes the class (type), position, size, and the like of the object in the front image. Note that, for example, unknown is set to the class of the object of which the class cannot be recognized. Furthermore, the object recognition unit 281 calculates, for example, a score (hereinafter, referred to as a recognition score) within a range from 0 to 1 indicating the probability (reliability) that the class of the recognized object is correct. The object recognition unit 281 supplies information indicating the recognition result of the object to the software update processing unit 251.

In step S32, the object recognition unit 281 determines whether or not an unknown object has been recognized. In a case where the object recognition unit 281 recognizes an object of which the class cannot be recognized in the object recognition processing of step S31, it is determined that an unknown object is recognized, and the processing proceeds to step S33.

In step S33, the rushing out detection unit 282 performs rushing out detection processing. For example, the rushing out detection unit 282 calculates an optical flow (u, v) for each pixel between the front image in which the unknown object is recognized and the front image one frame before. The rushing out detection unit 282 detects corresponding points between the two front images on the basis of an optical flow (u, v) for each pixel. The rushing out detection unit 282 detects Ego-motion of the camera 51 on the basis of a corresponding point that satisfies the epipolar constraint among the detected corresponding points. The rushing out detection unit 282 calculates an optical flow (u, v) obtained by subtracting the Ego-motion of the camera 51 from the optical flow (u′, v′) of each pixel.

In addition, the rushing out detection unit 282 calculates a motion vector of each pixel on the basis of an optical flow (u′, v′) of each pixel. The rushing out detection unit 282 calculates, as a rushing out score, the number of pixels in which the magnitude of the component in the x direction (horizontal direction of the front image) of the motion vector is equal to or greater than a predetermined threshold value. The rushing out detection unit 282 determines that the rushing out is detected in a case where the rushing out score is equal to or greater than the predetermined threshold value, and determines that the rushing out is not detected in a case where the rushing out score is less than the predetermined threshold value.

The rushing out detection unit 282 supplies information indicating the detection result of the rushing out to the software update processing unit 251.

Thereafter, the processing proceeds to step S34.

Meanwhile, in a case where it is determined in step S32 that an unknown object is not recognized, the processing in step S33 is skipped, and the processing proceeds to step S34.

In step S34, the object recognition unit 281 determines whether or not the recognition accuracy has deteriorated. For example, the threshold value of the recognition score is set in advance for each class of the object by learning processing in advance. The object recognition unit 281 compares the calculated recognition score with the corresponding threshold value for each object recognized in the processing of step S31. In a case where there is an object whose recognition score is less than the threshold value, the object recognition unit 281 determines that the recognition accuracy has deteriorated, and the processing proceeds to step S35.

In step S35, the object recognition unit 281 determines whether or not a vehicle is recognized. In a case where a vehicle is included in the objects recognized in the processing of step S31, the object recognition unit 281 determines that the vehicle is recognized, and the processing proceeds to step S36.

In step S36, the special vehicle recognition unit 283 performs special vehicle recognition processing. Specifically, the special vehicle recognition unit 283 collates the feature of each special vehicle registered in advance with the feature of the vehicle recognized by the object recognition unit 281. The special vehicle recognition unit 283 calculates a special vehicle score indicating the similarity between the feature of each special vehicle and the recognized feature of the vehicle.

In a case where there is a special vehicle whose special vehicle score is equal to or greater than a predetermined threshold value, the special vehicle recognition unit 283 determines that the vehicle recognized by the object recognition unit 281 is the special vehicle. In this case, for example, the presence of a special vehicle is assumed as one of the causes of the degradation in the accuracy of the object recognition. Meanwhile, in a case where there is no special vehicle whose special vehicle score is equal to or greater than the predetermined threshold value, the special vehicle recognition unit 283 determines that a special vehicle is not recognized.

The special vehicle recognition unit 283 supplies information indicating the recognition result of the special vehicle to the software update processing unit 251.

Thereafter, the processing proceeds to step S37.

Meanwhile, in a case where it is determined in step S35 that a vehicle is not recognized, the processing of step S36 is skipped, and the processing proceeds to step S37.

In step S37, the object recognition unit 281 determines whether or not a person is recognized. In a case where a person is included in the object recognized in the processing of step S31, the object recognition unit 281 determines that the person is recognized, and the processing proceeds to step S38.

In step S38, the group-of-people recognition unit 284 performs group-of-people recognition processing. Specifically, the group-of-people recognition unit 284 collates the feature of the group of people registered in advance with the feature of the front image. The group-of-people recognition unit 284 calculates a group of people score indicating the similarity between the feature of the group of people and the feature of the preceding vehicle.

The group-of-people recognition unit 284 determines that the group of people is recognized in a case where the group of people score is greater than or equal to a predetermined threshold value. In this case, for example, the presence of a group of people is assumed as one of the causes of the degradation in the accuracy of the object recognition. Meanwhile, the group-of-people recognition unit 284 determines that the group of people is not recognized in a case where the group of people score is less than the predetermined threshold value.

The group-of-people recognition unit 284 supplies information indicating the recognition result of the group of people to the software update processing unit 251.

Thereafter, the recognition processing ends.

Meanwhile, in a case where it is determined in step S37 that a person is not recognized, the processing in step S38 is skipped, and the recognition processing ends.

Furthermore, in a case where it is determined in step S34 that the recognition accuracy has not deteriorated, the processing of steps S35 to S38 is skipped, and the recognition processing ends.

Returning to FIG. 9, in step S2, the software update control unit 261 determines whether or not the software needs to be updated. For example, in a case where the result of the recognition processing in step S1 satisfies any one of the following conditions, the software update control unit 261 determines that it is necessary to update the software (that is, software for automated driving and the like), and the processing proceeds to step S3.

1. An unknown object was recognized.

2. The recognition accuracy has deteriorated (there is an object whose recognition score is less than a predetermined threshold value).

In step S3, the software update control unit 261 determines whether or not it is a timing to give notification of the update of the software. In a case where it is determined that it is not the timing to give the notification of the update of the software, the processing returns to step S1.

For example, as will be described later, in a case where the update of the software is not permitted by the user, it is determined that the predetermined period after the update of the software is not permitted is not the timing for giving the notification of the update of the software.

Thereafter, the processing of steps S1 to S3 is repeatedly executed until it is determined in step S2 that the update of the software is not necessary or it is determined in step S3 that it is the timing to give the notification of the update of the software.

Meanwhile, in a case where it is determined in step S3 that it is the timing to give the notification of the update of the software, the processing proceeds to step S4.

In step S4, the vehicle 1 transmits the recognition result. Specifically, the software update control unit 261 generates recognition processing information including the recognition result by the recognition unit 73 in the processing of step S1.

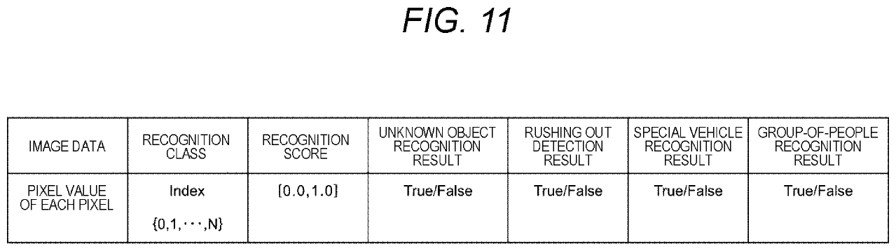

FIG. 11 illustrates a configuration example of the recognition processing information.

The recognition processing information includes image data, a recognition class, a recognition score, an unknown object recognition result, a rushing out detection result, a special vehicle recognition result, and a group-of-people recognition result.

The image data is image data indicating a pixel value of each pixel of the front image used for the recognition processing.

The recognition class is data indicated by the class of the recognized object. For example, different indexes are allocated to each object to be recognized, and an index representing a type of the recognized object is set in the recognition class. In a case where a plurality of types of objects is recognized, an index corresponding to each object type is set in the recognition class.

As the recognition score, a recognition score of the recognized object is set. In a case where a plurality of objects is recognized, a recognition score for each object is set. As described above, the recognition score is set to a value ranging from 0.0 to 1.0.

The unknown object recognition result is set to True in a case where an unknown object is recognized, and set to False in a case where an unknown object is not recognized.

The rushing out detection result is set to True in a case where rushing out is detected, and is set to False in a case where rushing out is not detected.

The special vehicle recognition result is set to True in a case where a special vehicle is recognized, and is set to False in a case where a special vehicle is not recognized.

The group-of-people recognition result is set to True in a case where a group of people is recognized, and is set to False in a case where a group of people is not recognized.

The software update control unit 261 transmits the recognition processing information to the management server 211 via the communication unit 22 and the network 212.

Meanwhile, as will be described later, the management server 211 selects software for automated driving or the like that needs to be updated in the vehicle 1 on the basis of the recognition processing information or the like. Then, the management server 211 transmits update software information related to the selected software for automated driving and the like (update software) to the vehicle 1.

The update software information includes, for example, the presence or absence of the update software, information regarding the update software, the URL of the website on which the information regarding the update software is displayed, and the like. The information regarding the update software includes, for example, a name, a function, an update date, a version, a URL indicating an acquisition source, and the like.

Meanwhile, in step S5, the communication unit 22 receives the update software information from the management server 211 via the network 212. The communication unit 22 supplies the update software information to the software update processing unit 251.

In step S6, the software update control unit 261 determines whether or not there is software that needs to be updated on the basis of the update software information. In a case where no update software is selected by the management server 211, the software update control unit 261 determines that there is no software that needs to be updated, and the processing returns to step S1.

Thereafter, the processing of steps S1 to S6 is repeatedly executed until it is determined in step S2 that the software does not need to be updated or it is determined in step S6 that there is software that needs to be updated.

Meanwhile, in step S6, in a case where one or more update software is selected by the management server 211, the software update control unit 261 determines that there is software that needs to be updated, and the processing proceeds to step S7.

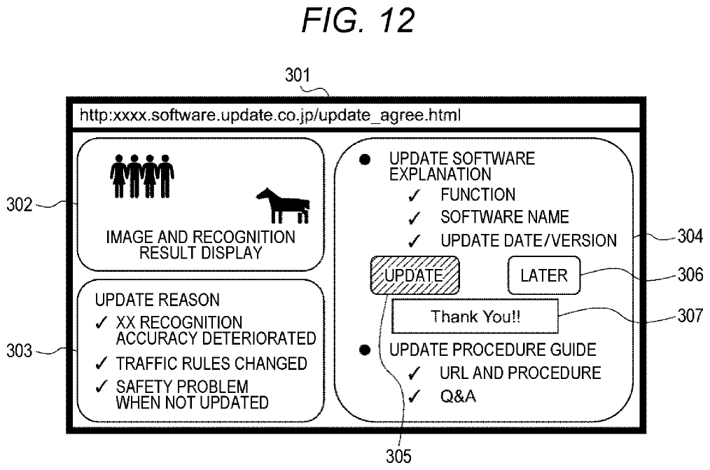

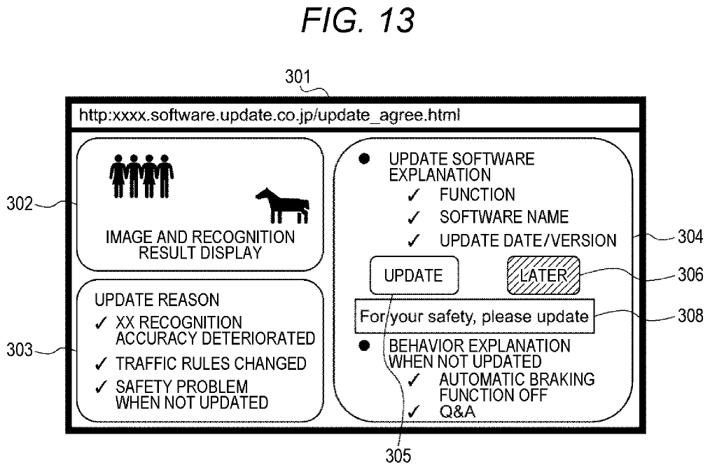

In step S7, the HMI 31 displays information regarding the update software under the control of the software update control unit 261. For example, the software update control unit 261 supplies the URL included in the update software information to the HMI 31. The HMI 31 accesses the acquired URL via the communication unit 22 and the network 212. As a result, for example, the screen of the website illustrated in FIG. 12 or 13 is displayed on the HMI 31.

On the screens of FIGS. 12 and 13, an address bar 301 and windows 302 to 304 are displayed.

The address bar 301 indicates the URL of the displayed website.

The front image and the recognition result used for the recognition processing in step S1 are displayed in the window 302. As a result, the user can easily grasp the recognition accuracy or the like of the recognition unit 73 of the vehicle 1. Furthermore, the user can recognize, for example, the reason why it is necessary to update the software for automated driving and the like.

The window 303 displays the reason why the software for automated driving or the like needs to be updated. For example, reasons such as the detection of rushing out of an unknown object, the low recognition score of a special vehicle, and the low recognition score of a group of people are displayed. For example, a reason for recommending update of software such as degradation in recognition accuracy or change in traffic rules is displayed. For example, a problem in a case where software is not updated such as a safety problem when not updated is displayed.

In the window 304, a description of the update software and information regarding an update procedure are displayed. For example, a function, a name, an update date, a version, and the like of the update software are displayed. For example, a link for displaying a URL of an acquisition source of the update software, an update procedure, and a Q&A regarding software update is displayed.

In addition, a button 305 and a button 306 are displayed in the window 304.

The button 305 is a button selected in a case where software is updated. When the button 305 is pressed, a message 307 welcoming the update of the software is displayed as illustrated in FIG. 12.

The button 306 is a button selected in a case where the software is not updated. When the button 306 is pressed, a message 308 prompting software update is displayed as illustrated in FIG. 13.

Note that the screens in FIGS. 12 and 13 can also be displayed on a display device different from the vehicle 1, such as a smartphone or a tablet terminal of the user, for example.

In step S8, the software update control unit 261 determines whether or not to update the software. Specifically, in a case where the button 305 or the button 306 is pressed on the screen of FIG. 12 or 13, the HMI 31 notifies the software update control unit 261 of the type of the pressed button. In a case where the button 306 is pressed, the software update control unit 261 determines not to update the software, and the processing proceeds to step S9.

Note that, in this case, for example, as described above in the processing of step S3, the notification of the update of the software is not performed until a predetermined time elapses. For example, the screen of FIG. 12 or 13 is not displayed until a predetermined time elapses.

In step S9, the vehicle 1 executes operation mode control processing.

Thereafter, the processing returns to step S1, and processing in and after step S1 is executed.

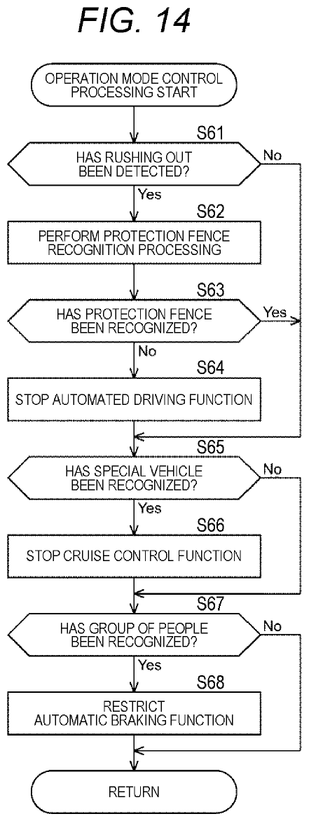

Here, details of the operation mode control processing will be described with reference to the flowchart of FIG. 14.

In step S61, the operation mode control unit 262 determines whether or not rushing out has been detected on the basis of the result of the rushing out detection processing in step S33 described above. In a case where it is determined that rushing out is detected, the processing proceeds to step S62.

In step S62, the protection fence recognition unit 285 performs protection fence recognition processing. Specifically, the operation mode control unit 262 instructs the protection fence recognition unit 285 to execute the protection fence recognition processing.

According to the instruction, the protection fence recognition unit 285 performs the protection fence recognition processing on the basis of the front image used in the recognition processing of step S1 described above. In a case where the recognition score of the protection fence is equal to or greater than a predetermined threshold value, the protection fence recognition unit 285 determines that a protection fence has been recognized. Meanwhile, in a case where the recognition score of the protection fence is less than the predetermined threshold value, the protection fence recognition unit 285 determines that a protection fence is not recognized.

The protection fence recognition unit 285 supplies information indicating a recognition result of the protection fence to the software update processing unit 251.

In step S63, the operation mode control unit 262 determines whether or not a protection fence has been recognized on the basis of the result of the protection fence recognition processing in step S62. In a case where it is determined that a protection fence is not recognized, the processing proceeds to step S64.

In step S64, the operation control unit 63 stops the automated driving function.

For example, in a case where rushing out of an unknown object is recognized and a protection fence is not recognized (in a case where a protection fence is not provided), for example, there is a high possibility that an unknown object such as a wild animal rushes out to the roadway.

Meanwhile, for example, a situation in which an unknown object rushes out to the roadway is an unexpected situation for the automated driving function, and when the automated driving is continued, the vehicle 1 is more likely to collide with or come into contact with the unknown object. Therefore, the operation mode control unit 262 sets the operation mode of the vehicle 1 to a mode for stopping all functions of travel assistance and automated driving. As a result, the operation control unit 63 stops all the functions of the travel assistance and the automated driving.

Thereafter, the processing proceeds to step S65.

Meanwhile, in a case where it is determined in step S63 that a protection fence has been recognized, the processing in step S64 is skipped, and the processing proceeds to step S65. That is, In a case where a protection fence is present, there is a low possibility that an unknown object will rushes out to the roadway, so that the automated driving function is continued without being stopped.

Furthermore, in a case where it is determined in step S61 that rushing out is not detected, the processing of steps S62 to S64 is skipped, and the processing proceeds to step S65.

In step S65, the operation mode control unit 262 determines whether or not a special vehicle has been recognized on the basis of the result of the special vehicle recognition processing in step S36 described above. In a case where it is determined that a special vehicle has been recognized, the processing proceeds to step S66.

In step S66, the operation control unit 63 stops the cruise control function.

For example, since there is a possibility that a special vehicle does not follow the traffic rules as described above, in a case where the vehicle 1 follows the special vehicle by the cruise control function, there is a possibility of violating the traffic rules.

Meanwhile, the operation mode control unit 262 sets the operation mode of the vehicle 1 to a mode for stopping the cruise control function. As a result, the operation control unit 63 stops the cruise control function.

Thereafter, the processing proceeds to step S67.

Meanwhile, in a case where it is determined in step S65 that a special vehicle is not recognized, the processing of step S66 is skipped, and the processing proceeds to step S67.

In step S67, the operation mode control unit 262 determines whether or not a group of people has been recognized on the basis of the result of the group-of-people recognition processing in step S38 described above. In a case where it is determined that a group of people has been recognized, the processing proceeds to step S68.

In step S68, the operation control unit 63 restricts the automatic braking function.

For example, in a case where a group of people is present, since the movement of the people is complicated, when the automatic braking function is operated as usual, there is a possibility that the automatic braking function malfunctions or operates frequently. Therefore, a sense of discomfort or trouble is caused in driving, or conversely, a risk of collision or contact with a person increases.

Meanwhile, the operation mode control unit 262 sets the operation mode of the vehicle 1 to a mode for restricting the automatic braking function. Thus, the operation control unit 63 restricts a part of the operation of the automatic braking function. For example, the operation control unit 63 limits the speed of the vehicle 1, and only issues a warning to the user (driver) without automatically operating the brake in a situation where it is estimated that the brake is necessary. As a result, the safety of the vehicle 1 is secured without causing discomfort or trouble in driving.

Thereafter, the operation mode control processing ends.

Meanwhile, in a case where it is determined in step S67 that a group of people is not recognized, the processing of step S68 is skipped, and the operation mode control processing ends.

Returning to FIG. 9, meanwhile, in step S8, in a case where the button 305 is pressed on the screen of FIG. 12 or 13, the software update control unit 261 determines to update the software, and the processing proceeds to step S10.

In step S10, the software update control unit 261 requests update software. Specifically, the software update control unit 261 generates update software request information for requesting transmission of update software to be updated in the update software information. The software update control unit 261 transmits update software request information to the management server 211 via the communication unit 22 and the network 212.

Meanwhile, as will be described later, the management server 211 transmits update software to the vehicle 1.

Meanwhile, in step S11, the software update control unit 261 receives the update software from the management server 211 via the network 212 and the communication unit 22.

In step S12, the software update control unit 261 updates the software. Specifically, the software update control unit 261 installs the received update software in the recording unit 28. As a result, the software for automated driving or the like whose version recorded in the recording unit 28 is old is updated by the update software.

Thereafter, the processing returns to step S1, and processing in and after step S1 is executed.

Meanwhile, in a case where it is determined in step S2 that the software does not need to be updated, the processing proceeds to step S13.

In step S13, the operation mode control unit 262 determines whether or not the travel assistance/automated driving is restricted. In a case where at least one of the automated driving function, the automatic cruising function, or the automatic braking function is restricted (including stopped) by the processing in step S9 described above, the operation mode control unit 262 determines that the travel assistance/automated driving is restricted, and the processing proceeds to step S14.

In step S14, the operation control unit 63 cancels the restriction of the travel assistance/automated driving. Specifically, the operation mode control unit 262 sets the operation mode of the vehicle 1 to the normal mode. As a result, the operation control unit 63 cancels the restriction of the function of the travel assistance or the automated driving.

Thereafter, the processing returns to step S1, and processing in and after step S1 is executed.

Meanwhile, in a case where it is determined in step S13 that the travel assistance/automated driving is not restricted, the processing of step S14 is skipped, and the processing returns to step S1. Thereafter, the processing in and after step S1 is executed.

### Software Provision Processing

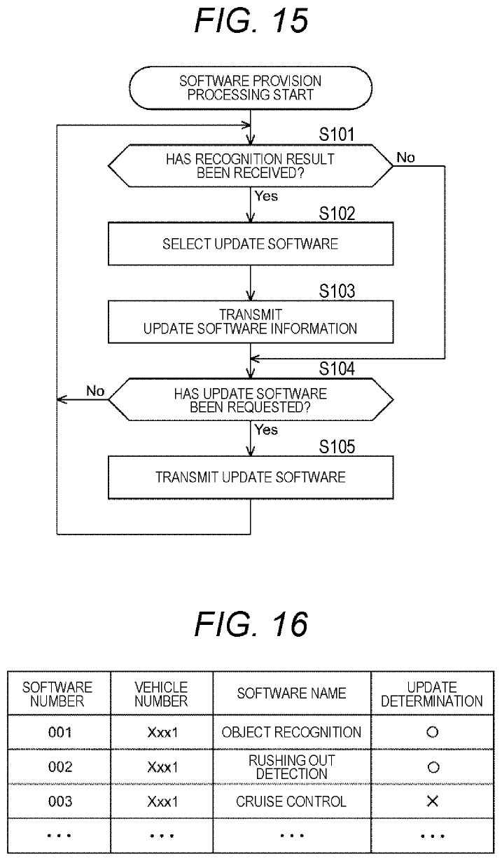

Next, software provision processing executed by the management server 211 corresponding to the software update control processing by the vehicle 1 of FIG. 9 will be described with reference to the flowchart of FIG. 15.

In step S101, the software management unit 231 determines whether or not a recognition result has been received. In a case of receiving the recognition processing information transmitted from the vehicle 1 in the processing in step S4 of FIG. 9 described above via the network 212 and the communication unit 234, the software management unit 231 determines that the recognition result has been received, and the processing proceeds to step S102.

In step S102, the software management unit 231 selects update software.

Here, a specific example of a method of selecting update software will be described with reference to FIGS. 16 to 18.

First, a first embodiment of a method for selecting update software will be described with reference to FIG. 16.

For example, the software management unit 231 acquires data regarding software installed in the vehicle 1 from the vehicle DB 236 via the vehicle management unit 232, and acquires pre-registration information regarding the vehicle 1 from the registration information DB 237.

Next, the software management unit 231 compares the version of each piece of software for automated driving and the like installed in the vehicle 1 with the latest version registered in the software DB 235. Then, the software management unit 231 extracts software for automated driving or the like for which a newer version than the version installed in the vehicle 1 exists. However, in a case where a new version of software for automated driving or the like is set to be non-updateable, the software is excluded.

Next, the software management unit 231 selects update software from the extracted software for automated driving and the like on the basis of the use condition of the vehicle 1.

For example, as illustrated in FIG. 16, in a case where there are new versions of the object recognition software, the rushing out detection software, and the cruise control function software, the above three pieces of software are candidates for update software. Meanwhile, in a case where the vehicle 1 does not use the cruise control function due to the pre-registration information regarding the vehicle 1, the software for the cruise control function is excluded from the update software. As a result, the object recognition software and the rushing out detection software are selected as the update software.

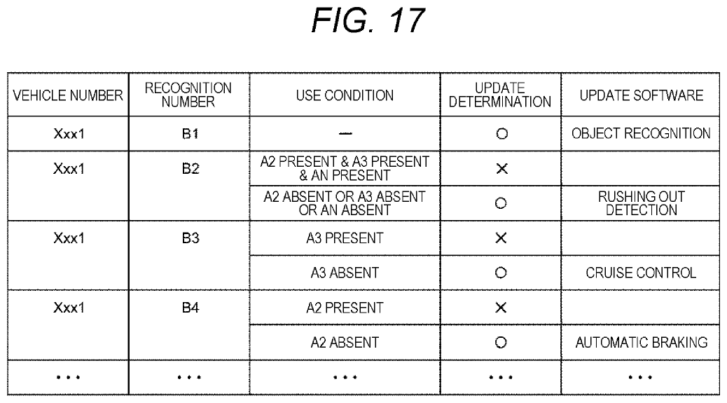

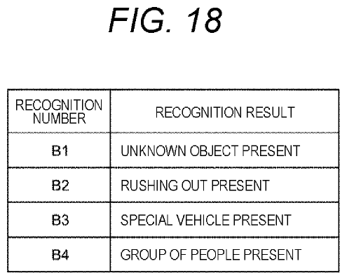

Next, a second embodiment of update software selection processing will be described with reference to FIGS. 17 and 18.

FIG. 17 is a table illustrating an example of a selection result of the update software.

In the second embodiment, update software is further selected on the basis of the recognition result of the vehicle 1.

Note that A1 to AN in the use condition of FIG. 17 indicate registration numbers of the pre-registration information of FIG. 7. “Present” and “Absent” after A1 to AN indicate whether or not the use conditions A1 to AN are satisfied. For example, “A1 present” indicates that an expressway is not used, and “A1 absent” indicates that an expressway is used. “A2 present” indicates that the automatic braking function is not used, and “A2 absent” indicates that the automatic braking function is used. “A3 present” indicates that the cruise control function is not used, and “A3 absent” indicates that the cruise control function is used. “A4 present” indicates that a toll road is not used, and “A4 absent” indicates that a toll road is used. “AN present” indicates that the automatic parking function is not used, and “AN absent” indicates that the automatic parking function is used.

Recognition numbers B1 to B4 in FIG. 17 correspond to the recognition results illustrated in FIG. 18, respectively. Specifically, the recognition number B1 indicates that an unknown object has been recognized. The recognition number B2 indicates that rushing out is detected. The recognition number B3 indicates that a special vehicle has been recognized. The recognition number B4 indicates that a group of people is recognized.

For example, in a case where an unknown object is recognized, there is a possibility that a serious risk occurs in all functions of travel assistance and automated driving. Therefore, in a case where there is software for object recognition newer than the version installed in the vehicle 1, the software is selected as the update software regardless of the use condition of the vehicle 1.

For example, in a case where rushing out is detected, when the vehicle 1 uses the automatic braking function, the cruise control function, or the automatic parking function (when A2 is absent, A3 is absent, or AN is absent), required accuracy of rushing out detection is increased. Therefore, in a case where there is software for rushing out detection newer than the version installed in the vehicle 1, the software is selected as the update software. Meanwhile, for example, even if rushing out is detected, when the vehicle 1 does not use any of the automatic braking function, the cruise control function, and the automatic parking function (when A2 is absent, and A3 is absent, and AN is absent), the required accuracy of rushing out detection is not so high. Therefore, even if there is software for rushing out detection newer than the version installed in the vehicle 1, the software is not selected as update software.

For example, in a case where a special vehicle is recognized, when the vehicle 1 uses the cruise control function (when A3 is absent), there is a possibility that the vehicle 1 follows the special vehicle and travels without following the traffic rules. Therefore, in a case where there is software for the cruise control function newer than the version installed in the vehicle 1, the software is selected as update software. Meanwhile, even if a special vehicle is recognized, when the vehicle 1 does not use the cruise control function (when A3 is present), the software is not selected as update software.

For example, in a case where a group of people is recognized, when the vehicle 1 uses the automatic braking function (when A2 is absent), there is a possibility that the automatic braking function malfunctions or operates more than necessary. Therefore, in a case where software for the automatic braking function newer than the version installed in the vehicle 1 is present, the software is selected as the update software. Meanwhile, even if a group of people is recognized, when the vehicle 1 does not use the automatic braking function (when A2 is present), the software is not selected as the update software.

As described above, by selecting the update software by combining the recognition result and the use condition of the vehicle 1, the update software is more appropriately selected according to the situation of each vehicle 1.

Referring back to FIG. 15, in step S103, the software management unit 231 transmits the update software information. Specifically, the software management unit 231 generates update software information including information regarding the update software selected in the processing of step S102. As described above, the update software information includes, for example, the presence or absence of the update software, the information regarding the update software, the URL of the website on which the information regarding the update software is displayed, and the like.

The software management unit 231 transmits the update software information to the vehicle 1 via the communication unit 234 and the network 212.

Thereafter, the processing proceeds to step S104.

Meanwhile, in a case where it is determined in step S101 that the recognition result has not been received, the processing in steps S102 and S103 is skipped, and the processing proceeds to step S104.

In step S104, the software management unit 231 determines whether or not update software has been requested. In a case where the software management unit 231 receives the update software request information transmitted from the vehicle 1 in the processing of step S10 of FIG. 9 described above via the network 212 and the communication unit 234, the software management unit determines that the update software is requested, and the processing proceeds to step S105.

In step S105, the software management unit 231 transmits the update software. Specifically, the software management unit 231 acquires update software to be transmitted from the software DB 235 on the basis of the update software request information. The software management unit 231 transmits the acquired update software to the requester vehicle 1 via the communication unit 234 and the network 212.

Thereafter, the processing returns to step S101, and the processing in and after step S101 are executed.

Meanwhile, in a case where it is determined in step S104 that the update software is not requested, the processing returns to step S101, and the processing in and after step S101 is executed.

As described above, the update software is appropriately selected on the basis of the situation of each vehicle 1, for example, the use condition and the recognition result of each vehicle 1. That is, for example, the minimum necessary update software is selected on the basis of the preference of the user of each vehicle 1, the specification of the vehicle 1, the performance of the recognition function, and the like.

As a result, for example, the update frequency of the software for automated driving and the like can be reduced while ensuring the safety of the vehicle 1, and the satisfaction of the user is improved. For example, the cost and effort required for updating the software for automated driving and the like are reduced. For example, the notification for prompting the update of the software is frequently performed, and the user is prevented from being bothered.

In addition, each vehicle 1 can update the software at an appropriate timing without the management server 211 periodically giving notification of the update software. For example, it is possible to update the software for automated driving or the like at the timing when a deviation occurs in the mounting position of the camera 51, the camera 51 is replaced or added, the vehicle 1 enters a new region, or the like.

Furthermore, in a case where the installation of the update software is not permitted, the functions of the travel assistance and the automated driving of the vehicle 1 are restricted. As a result, the safety of the vehicle 1 is improved. For example, by restricting the function affected by the degradation in recognition accuracy, it is possible to suppress the influence of the degradation in recognition accuracy and secure safety.

Furthermore, for example, the learning unit 233 of the management server 211 relearns and reconstructs software by using the image data and the recognition result included in the recognition processing information, whereby the recognition accuracy of various kinds of recognition software can be improved.

### 3. Modifications

Hereinafter, modifications of the above-described embodiments of the present technology will be described.

For example, the update software selected by the management server 211 may be automatically installed in the vehicle 1 without being confirmed by the user. Also in this case, unnecessary update of software such as automated driving is suppressed.

For example, update software may be included in the update software information transmitted from the management server 211. Then, for example, in a case where the user permits, the update software included in the update software information may be installed in the vehicle 1.

For example, in a case where a plurality of pieces of update software is selected by the management server 211, the user may be allowed to individually select the update software to be installed.

For example, the type of the software for automated driving and the like described above is an example, and can be changed as necessary.

For example, the type of the recognition result used to select the update software can be changed as necessary. For example, it is possible to use a recognition result of recognition processing in a direction other than the front of the vehicle 1. For example, it is possible to use a recognition result of recognition processing using sensor data of a sensor (for example, the radar 52, the LiDAR 53, the ultrasonic sensor 54, and the like) other than the camera 51. In this case, for example, the recognition processing information includes sensor data used for the recognition processing or a feature amount of the sensor data.

For example, in a case where the management server 211 does not use the recognition result for selecting the update software, the vehicle 1 does not necessarily need to transmit the recognition result to the management server 211 when determining that the software needs to be updated on the basis of the recognition result. For example, the vehicle 1 may request the management server 211 to select update software without transmitting the recognition result.

The above-described functions of travel assistance and automated driving are examples, and can be changed as necessary.

For example, in a case where the installation of the update software fails, the functions of the travel assistance and the automated driving may be restricted similarly in the case where the update of the update software is not permitted.

For example, a server different from the management server 211 may provide update software.

The present technology can be applied to, for example, a mobile body traveling on a road other than the vehicle 1. Furthermore, the present technology can also be applied to, for example, a mobile body on which no person boards. For example, the present technology can be applied to a robot or the like that moves on a road in an unmanned manner and carries a load.

### 4. Others

### Configuration Example of Computer

The above-described series of processing can be executed by hardware or software. In a case where the series of processing is executed by software, a program constituting the software is installed in a computer. Here, the computer includes a computer incorporated in dedicated hardware, a general-purpose personal computer capable of executing various functions by installing various programs, and the like, for example.

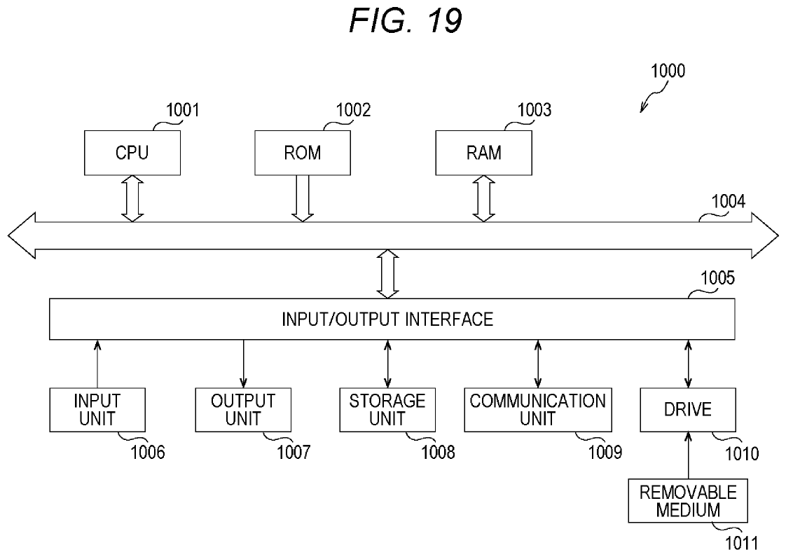

FIG. 19 is a block diagram illustrating a configuration example of hardware of a computer that executes the above-described series of processing with a program.

In a computer 1000, a central processing unit (CPU) 1001, a read only memory (ROM) 1002, and a random access memory (RAM) 1003 are mutually connected by a bus 1004.

An input/output interface 1005 is further connected to the bus 1004. An input unit 1006, an output unit 1007, a recording unit 1008, a communication unit 1009, and a drive 1010 are connected to the input/output interface 1005.

The input unit 1006 includes an input switch, a button, a microphone, an imaging element, and the like. The output unit 1007 includes a display, a speaker, and the like. The recording unit 1008 includes a hard disk, a nonvolatile memory, and the like. The communication unit 1009 includes a network interface and the like. The drive 1010 drives a removable medium 1011 such as a magnetic disk, an optical disk, a magneto-optical disk, or a semiconductor memory.

In the computer 1000 configured as described above, for example, the CPU 1001 loads a program recorded in the recording unit 1008 into the RAM 1003 via the input/output interface 1005 and the bus 1004 and executes the program, whereby the above-described series of processing is performed.

The program executed by the computer 1000 (CPU 1001) can be provided by being recorded in the removable medium 1011 as a package medium or the like, for example. Furthermore, the program can be provided via a wired or wireless transmission medium such as a local area network, the Internet, or digital satellite broadcasting.

In the computer 1000, the program can be installed in the recording unit 1008 via the input/output interface 1005 by attaching the removable medium 1011 to the drive 1010. Furthermore, the program can be received by the communication unit 1009 via a wired or wireless transmission medium and installed in the recording unit 1008. In addition, the program can be installed in the ROM 1002 or the recording unit 1008 in advance.

Note that the program executed by the computer may be a program in which processing is performed in time series in the order described in the present specification, or may be a program in which processing is performed in parallel or at necessary timing such as when a call is made or the like.

Furthermore, in the present specification, a system means a set of a plurality of components (devices, modules (parts), or the like), and it does not matter whether or not all the components are in the same housing. Therefore, a plurality of devices housed in separate housings and connected via a network and one device in which a plurality of modules is housed in one housing are both systems.

Moreover, the embodiments of the present technology are not limited to the above-described embodiments, and various modifications can be made without departing from the gist of the present technology.

For example, the present technology can have a configuration of cloud computing in which one function is shared and processed in cooperation by a plurality of devices via a network.

Furthermore, each step described in the above-described flowcharts can be executed by one device or can be shared and executed by a plurality of devices.

Moreover, in a case where a plurality of processes is included in one step, the plurality of processes included in the one step can be executed by one device or can be shared and executed by a plurality of devices.

### Combination Example of Configuration

The present technology can also have the following configurations.

(1)

An information processing device including:
a recognition unit that performs recognition processing of a situation around a mobile body on the basis of sensor data regarding the situation around the mobile body; and
a software update control unit that controls update of software used for travel assistance or automated driving of the mobile body on the basis of a recognition result of the recognition processing.

(2)

The information processing device according to (1),
in which the software update control unit determines necessity of updating the software on the basis of the recognition result.

(3)

The information processing device according to (2),
in which in a case where the software update control unit determines that the software needs to be updated, the software update control unit transmits recognition processing information including the recognition result to a first information processing device that selects update software to be used for updating the software.

(4)

The information processing device according to (3),
in which the software update control unit receives, from the first information processing device, update software information including information regarding the update software selected using the recognition result.

(5)

The information processing device according to (4),
in which the software update control unit controls presentation of the information regarding the update software on the basis of the update software information.

(6)

The information processing device according to (5),
in which the software update control unit installs the update software on the mobile body in a case where installation of the update software for which information is presented is permitted.

(7)

The information processing device according to (6),
in which in a case where the installation of the update software is permitted, the software update control unit acquires the update software from the first information processing device or a second information processing device different from the first information processing device.

(8)

The information processing device according to any one of (5) to (7), further including
an operation control unit that restricts at least a part of the functions of the travel assistance and the automated driving in a case where the update software is not installed.

(9)

The information processing device according to (8),
in which in a case where the update software is not installed, the operation control unit stops an automated driving function of the mobile body when rushing out is detected by the recognition processing and a protection fence is not recognized by the recognition processing.

(10)

The information processing device according to (8) or (9),
in which in a case where the update software is not installed, the operation control unit stops a cruise control function when a special vehicle is recognized by the recognition processing.

(11)

The information processing device according to any one of (8) to (10),
in which in a case where the update software is not installed, the operation control unit restricts an automatic braking function when a group of people is recognized by the recognition processing.

(12)

The information processing device according to any one of (5) to (11),
in which the software update control unit controls presentation of a reason for updating the software together with the information regarding the update software.

(13)

The information processing device according to (12),
in which the sensor data includes image data, and
the software update control unit controls presentation of the image data and the recognition result in which accuracy of the recognition processing has deteriorated as a reason for updating the software.

(14)

The information processing device according to any one of (3) to (13),
in which the recognition processing information includes the sensor data used for the recognition processing.

(15)

The information processing device according to any one of (2) to (14),
in which the recognition processing includes object recognition processing, and
the software update control unit determines that the software needs to be updated in a case where reliability of the object recognition processing is less than a predetermined threshold value or in a case where an unknown object is recognized.

(16)

An information processing method including:
performing recognition processing of a situation around a mobile body on the basis of sensor data regarding the situation around the mobile body; and
controlling update of software used for travel assistance or automated driving of the mobile body on the basis of a recognition result of the recognition processing.

(17)

An information processing system including:
a first information processing device provided in a mobile body; and
a second information processing device,
in which the first information processing device includes:
a recognition unit that performs recognition processing of a situation around the mobile body on the basis of sensor data regarding the situation around the mobile body; and
a software update control unit that determines whether or not it is necessary to update software used for travel assistance or automated driving of the mobile body on the basis of a recognition result of the recognition processing, and
the second information processing device includes
a software management unit that selects update software to be used for updating the software on the basis of a use condition of the mobile body in a case where the first information processing device determines that the software needs to be updated.

(18)

The information processing system according to (17),
in which the software update control unit transmits recognition processing information including the recognition result to the second information processing device in a case where it is determined that the software needs to be updated, and
the software management unit selects the update software on the basis of the recognition result and the use condition.

(19)

The information processing system according to (17) or (18),
in which the software management unit controls transmission of update software information including information regarding the update software to the first information processing device.

(20)

The information processing system according to (19),
in which the update software information includes a reason for updating the software.

(21)

An information processing device including:
a software management unit that selects update software to be used for update of software on the basis of a use condition of a mobile body in a case where another information processing device provided in the mobile body determines that the update of the software to be used for travel assistance or automated driving of the mobile body is necessary.

(22)

The information processing device according to (21),
in which the another information processing device performs recognition processing of a situation around the mobile body on the basis of sensor data regarding a situation around the mobile body, and transmits recognition processing information including a recognition result of the recognition processing in a case where it is determined that the update of the software is necessary on the basis of the recognition result, and
the software management unit receives the recognition processing information and selects the update software on the basis of the recognition result and the use condition.

(23)

The information processing device according to (22),
in which the recognition processing includes object recognition processing, and
the software management unit selects software for object recognition as the update software in a case where reliability of the object recognition processing is less than a predetermined threshold value or in a case where an unknown object is recognized.

(24)

The information processing device according to (22) or (23),
in which the recognition processing information includes the sensor data used for the recognition processing,
the information processing device further including a learning unit that performs learning of the recognition processing on the basis of the sensor data and the recognition result,

(25)

The information processing device according to any one of (21) to (24),
in which the software management unit controls transmission of update software information including information regarding the update software to the first information processing device.

(26)

The information processing device according to (25),
in which the update software information includes a reason for updating the software.

Note that the effects described in the present specification are merely examples and are not limited, and other effects may be provided.

### REFERENCE SIGNS LIST

1, 1-1 to 1-n Vehicle
11, 11-1 to 11-n Vehicle control system
25 External recognition sensor
28 Recording unit
29 Travel assistance/automated driving control unit
31 HMI
51 Camera
63 Operation control unit
73 Recognition unit
201 Information processing system
211 Management server
231 Software management unit
232 Vehicle management unit
233 Learning unit
251 Software update processing unit
261 Software update control unit
262 Operation mode control unit
281 Object recognition unit
282 Rushing out detection unit
283 Special vehicle recognition unit
284 Group-of-people recognition unit
285 Protection fence recognition unit

1. An information processing device comprising:
a recognition unit that performs recognition processing of a situation around a mobile body on a basis of sensor data regarding the situation around the mobile body; and
a software update control unit that controls update of software used for travel assistance or automated driving of the mobile body on a basis of a recognition result of the recognition processing.

2. The information processing device according to claim 1,
wherein the software update control unit determines necessity of updating the software on a basis of the recognition result.

3. The information processing device according to claim 2,
wherein in a case where the software update control unit determines that the software needs to be updated, the software update control unit transmits recognition processing information including the recognition result to a first information processing device that selects update software to be used for updating the software.

4. The information processing device according to claim 3,
wherein the software update control unit receives, from the first information processing device, update software information including information regarding the update software selected using the recognition result.

5. The information processing device according to claim 4,
wherein the software update control unit controls presentation of the information regarding the update software on a basis of the update software information.

6. The information processing device according to claim 5,
wherein the software update control unit installs the update software on the mobile body in a case where installation of the update software for which information is presented is permitted.

7. The information processing device according to claim 6,
wherein in a case where the installation of the update software is permitted, the software update control unit acquires the update software from the first information processing device or a second information processing device different from the first information processing device.

8. The information processing device according to claim 5, further comprising
an operation control unit that restricts at least a part of the functions of the travel assistance and the automated driving in a case where the update software is not installed.

9. The information processing device according to claim 8,
wherein in a case where the update software is not installed, the operation control unit stops an automated driving function of the mobile body when rushing out is detected by the recognition processing and a protection fence is not recognized by the recognition processing.

10. The information processing device according to claim 8,
wherein in a case where the update software is not installed, the operation control unit stops a cruise control function when a special vehicle is recognized by the recognition processing.

11. The information processing device according to claim 8,
wherein in a case where the update software is not installed, the operation control unit restricts an automatic braking function when a group of people is recognized by the recognition processing.

12. The information processing device according to claim 5,
wherein the software update control unit controls presentation of a reason for updating the software together with the information regarding the update software.

13. The information processing device according to claim 12,
wherein the sensor data includes image data, and
the software update control unit controls presentation of the image data and the recognition result in which accuracy of the recognition processing has deteriorated as a reason for updating the software.

14. The information processing device according to claim 3,
wherein the recognition processing information includes the sensor data used for the recognition processing.

15. The information processing device according to claim 2,
wherein the recognition processing includes object recognition processing, and
the software update control unit determines that the software needs to be updated in a case where reliability of the object recognition processing is less than a predetermined threshold value or in a case where an unknown object is recognized.

16. An information processing method comprising:
performing recognition processing of a situation around a mobile body on a basis of sensor data regarding the situation around the mobile body; and
controlling update of software used for travel assistance or automated driving of the mobile body on a basis of a recognition result of the recognition processing.

17. An information processing system comprising:
a first information processing device provided in a mobile body; and
a second information processing device,
wherein the first information processing device includes:
a recognition unit that performs recognition processing of a situation around the mobile body on a basis of sensor data regarding the situation around the mobile body; and
a software update control unit that determines whether or not it is necessary to update software used for travel assistance or automated driving of the mobile body on a basis of a recognition result of the recognition processing, and
the second information processing device includes
a software management unit that selects update software to be used for updating the software on a basis of a use condition of the mobile body in a case where the first information processing device determines that the software needs to be updated.

18. The information processing system according to claim 17,
wherein the software update control unit transmits recognition processing information including the recognition result to the second information processing device in a case where it is determined that the software needs to be updated, and
the software management unit selects the update software on a basis of the recognition result and the use condition.

19. The information processing system according to claim 17,
wherein the software management unit controls transmission of update software information including information regarding the update software to the first information processing device.

20. The information processing system according to claim 19,
wherein the update software information includes a reason for updating the software.
